(19) United States
(12) Patent Application Publication
(10) Pub. No.: US 2010/0131938 A1
(43) Pub. Date: May 27, 2010

(54) RECORDING MEDIUM ENCODED WITH UPDATE FUNCTION VERIFICATION PROGRAM, UPDATE FUNCTION VERIFICATION METHOD, AND INFORMATION PROCESSING DEVICE

(75) Inventor: Yuichi TSUCHIMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/621,891

(22) Filed: Nov. 19, 2009

(30) Foreign Application Priority Data
Nov. 21, 2008 (JP) 2009-297788

(51) Int. Cl. G06F 9/44

(52) U.S. Cl. 717/168

(57) ABSTRACT

An information processing device verifies an update function. An initialization section creates, when an initialization function is called, verification-use data being a replica of original data. An update section updates, when an update function is called, the original data using the update function, and sequentially stores an argument of the update function to an update history. A reference section additionally stores, to the update history, when a reference function is called, at least one of the arguments selected from those in the update history in accordance with predetermined rules, and stores the arguments in the update history in the verification-use data while sequentially applying the arguments to the update function. An error section makes a comparison between the original data and the verification-use data including the arguments and, when there is a difference therebetween, executes a predetermined error process.

### CROSS-REFERENCE TO RELATED APPLICATIONS

This application is based upon and claims the benefit of priority of the prior Japanese Patent Application No. 2008-297788, filed on Nov. 21, 2008, the entire contents of which are incorporated herein by reference.

### FIELD

Various embodiments described herein relate to a technology for verifying the commutativity and idempotency of an update function in a distributed-data sharing device in which a user can define the update function.

### BACKGROUND

A distributed-data sharing device is popularly used with heavy-traffic Web sites and others for data sharing among a plurality of servers for of improving the performance. In such a distributed-data sharing device, for ensuring the availability of throughput in case of a failure and the throughput of reference use, in some cases, a plurality of servers each carry a replica of master data. In such cases, for increasing the throughput of parallel update while keeping the consistency of the replicas, it is desirable to design an update function for use with data update with satisfactory commutativity and idempotency. If the update function is with the satisfactory commutativity, the replicas can be updated with no concern for the update order of the update function and others. If the update function is with the satisfactory idempotency, after any of the replicas is updated by a specific update function, the replica can be updated again by the same update function. This accordingly eases the control over such data update, thereby being able to reduce the load in the entire distributed-data sharing device. Herein, the update function denotes a function in which rules of data update are defined. The expression of “the update function is with the satisfactory commutativity” means that the result of data update remains the same even if the data is updated in various different orders. On the other hand, the expression of “the update function is with the satisfactory idempotency” means that, even if the data is updated similarly for a plurality of times, the result thereof is the same as the result of data updated only once. As an exemplary update function satisfying both the commutativity and idempotency, there is a function of holding one of two values that is larger than the other through a comparison therebetween, for example.

Some of such a distributed-data sharing device have a capability of allowing a user such as a person in charge of application development to define an update function. In this case, such a user-defined update function has to satisfy both the commutativity and idempotency.

The problem here is that verifying whether such a user-defined update function is actually satisfying both the commutativity and idempotency or not is difficult for the following reasons. That is, even if an update function is not satisfying both the commutativity and idempotency, a distributed-data sharing device often seems to be operating normally. Therefore, until the replicas are found as not consistent, the update function is not found as inappropriate. Further, because the states of the replicas are dependent on the performance order of parallel update, it is difficult to reproduce the case with the inappropriate update function. Still further, it is also difficult to prove in advance whether the update function is satisfying both the commutativity and idempotency or not by, for example, a compiler.

Therefore, in consideration of such problems, an object of the invention is to provide a technology for enabling verification of whether a user-defined update function is satisfying both the commutativity and idempotency or not.

### SUMMARY

An information processing device verifies an update function. An initialization section creates, when an initialization function is called, verification-use data being a replica of original data. An update section updates, when an update function is called, the original data using the update function, and sequentially stores an argument of the update function to an update history. A reference section additionally stores, to the update history, when a reference function is called, at least one of the arguments selected from those in the update history in accordance with predetermined rules, and stores the arguments in the update history in the verification-use data while sequentially applying the arguments to the update function. An error section makes a comparison between the original data and the verification-use data including the arguments, and, when there is a difference therebetween, executes a predetermined error process.

Additional aspects and/or advantages will be set forth in part in the description which follows and, in part, will be apparent from the description, or may be learned by practice of the various embodiments.

### BRIEF DESCRIPTION OF DRAWINGS

FIG. 1 is a configuration diagram of a distributed-data sharing device utilizing a client server system;

FIG. 2 is a function block diagram of a server;

FIG. 3 is a diagram showing the data configuration of an original data management table and that of a verification-use data management table;

FIG. 4 is a diagram showing the data configuration of an update history management table;

FIG. 5 is a flowchart of an initialization process to be executed in an initialization section;

FIG. 6 is a flowchart of an update process to be executed in an update section;

FIG. 7 is a flowchart of a reference process to be executed in a reference section;

FIG. 8A shows an exemplary initialized original data management table;

FIG. 8B shows an exemplary initialized verification-use data management table;

FIG. 8C shows an exemplary initialized update history management table;

FIG. 9A shows an exemplary updated original data management table;

FIG. 9B shows an exemplary updated verification-use data management table;

FIG. 9C shows an exemplary updated update history management table; and

FIG. 10 is a diagram illustrating an exemplary process to be executed at the time of reference.

### DESCRIPTION OF EMBODIMENTS

In the below, an embodiment is described in detail by referring to the accompanying drawings.

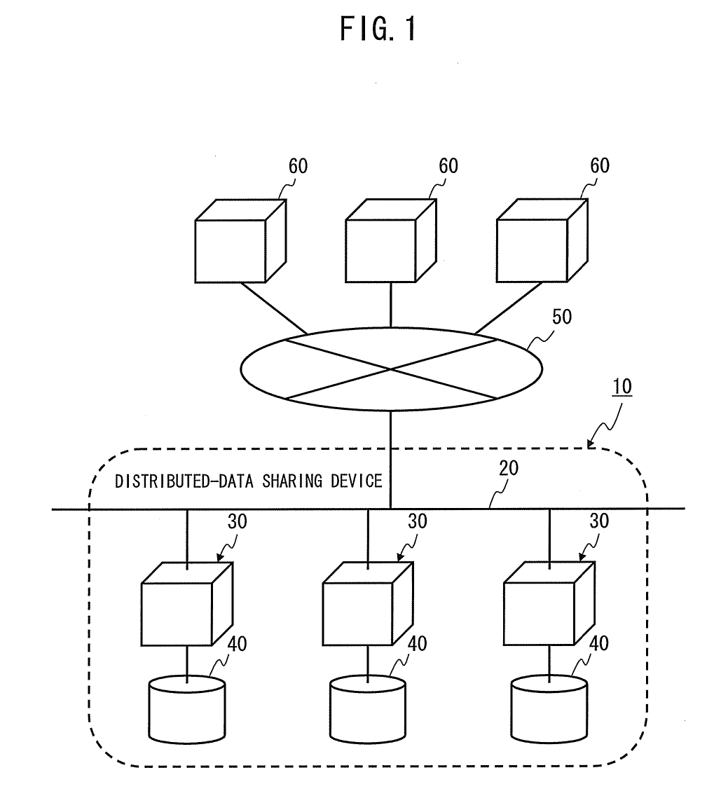

FIG. 1 shows an exemplary distributed-data sharing device utilizing a client server system. Note that the distributed-data sharing device of this embodiment has a capability of allowing a user, such as a person in charge of application development, to define an update function.

A distributed-data sharing device 10 is configured to include a plurality of servers 30, and a plurality of storages 40. The servers 30 are connected to one another over a network 20 such as LAN (Local Area Network), and the storages 40 are exemplified by hard disks, each under the management of the corresponding server 30. The storages 40 each store therein a replica of master data as original data. Herein, the master data means basic data being consistent among the storages 40. The servers 30 are each connected to at least one client 60 over a network 50 such as the Internet. The client 60 is the one that provides functions, i.e., initialization function, update function, and reference function, with respect to the original data on the distributed-data sharing device 10.

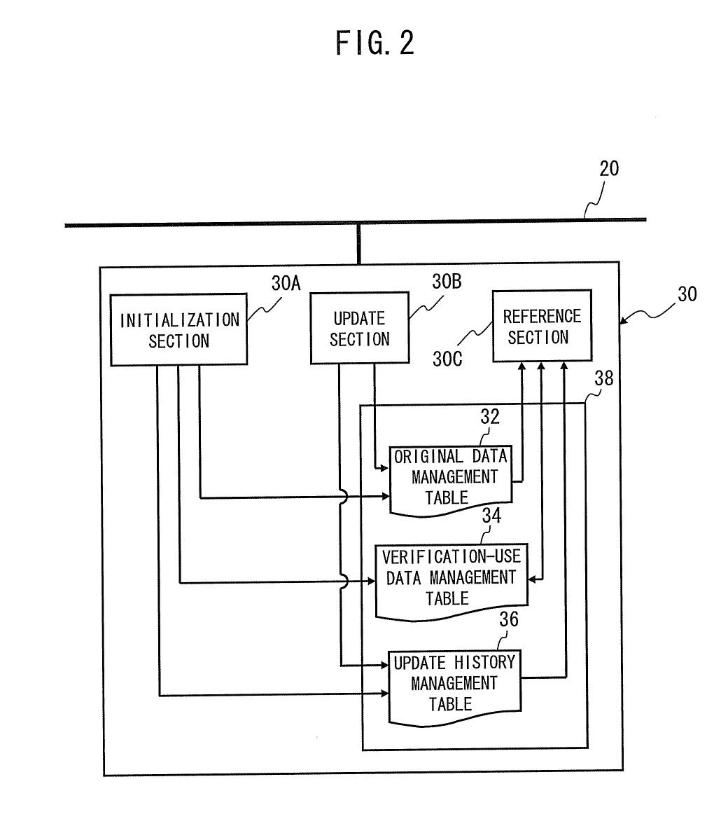

As shown in FIG. 2, the servers 30 are each provided with a storage section 38 that stores therein tables, i.e., an original data management table 32, a verification-use data management table 34, and an update history management table 36.

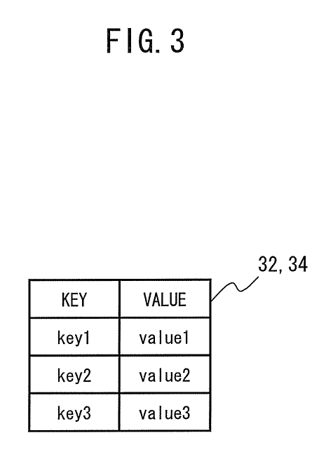

The original data management table 32 and the verification-use data management table 34 are provided for management of original data and verification-use data, respectively. The verification-use data is data used for verification of the commutativity and idempotency of an update function. As shown in FIG. 3, in such tables, entries of records are made each with a correlation between a “key” and a “value”. The “key” is the one specifying a variable to be used by a user-defined update function.

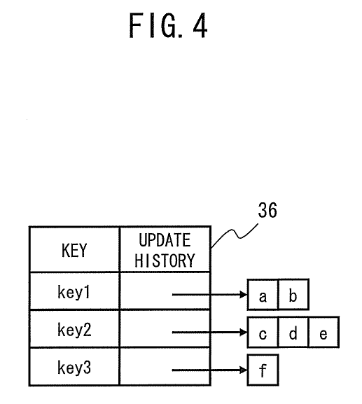

The update history management table 36 is provided to keep, as an update history, the “value” being an argument of the update function called by any of the clients 60. As shown in FIG. 4, in the update history table 36, entries of records are made each with a correlation between a “key” and an “update history”.

The servers 30 each run an update function verification program installed in an external storage device such as hard disk, thereby implementing the functions of components therein, i.e., an initialization section 30A, an update section 30B, and a reference section 30C, as shown in FIG. 2.

The initialization section 30A is operated to initialize the tables, i.e., the original data management table 32, the verification-use data management table 34, and the update history management table 36, when the initialization function is called by any of the clients 60. The argument of the initialization function is a “key” indicating a target for initialization, and a “value” indicating the initial value of the target. The initialization section 30A embodies steps and means for responding to the call of the initialization function. Herein, the term of “initialization” denotes an entry of an “initial value” with a correlation to a “key”.

When the update function is called by any of the clients 60, the update section 30B updates the original data management table 32, and successively makes an entry of an argument of the update function to the update history management table 36. The argument of the update function is a “key” indicating a target for update, and a “value” of the target. The update section 30B embodies steps and means for responding to the call of the update function.

When the reference function is called by any of the clients 60, the reference section 30C refers to the original data management table 32, and returns the result with respect to the reference function back to the client 60. The reference section 30C updates the verification-use data management table 34 based on the update history found in the update history management table 36. The reference section 30C makes a comparison between the records in the original data management table 32 and those in the verification-use data management table 34, thereby determining whether the user-defined update function is satisfying both the commutativity and idempotency. The argument of the reference function is a “key” indicating a target for reference. The reference section 30C embodies steps and means for responding to the call of the reference function.

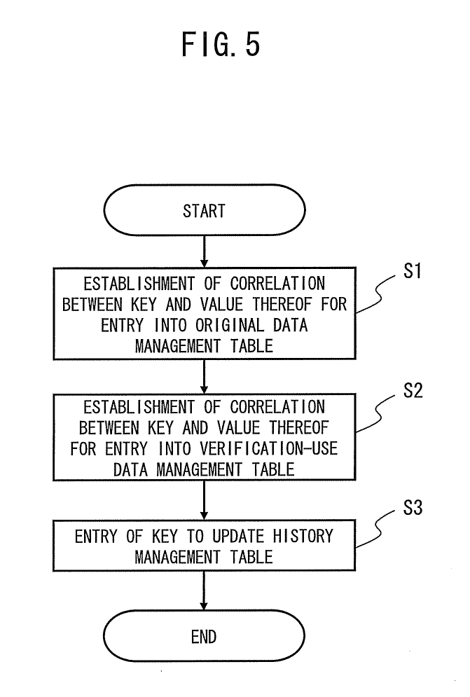

FIG. 5 is a flowchart of an initialization process to be executed by the initialization section 30A when an initialization function (init function) is called by any of the clients 60. For execution of the initialization process, the tables, i.e., the original data management table 32, the verification-use data management table 34, and the update history management table 36, are assumed as all being cleared.

In step S1 (simply referred to as S1 in the drawing; the same is also applicable below), the initialization section 30A makes an entry to the original data management table 32 with a correlation between a “key” being the argument of the initialization function called by the client 60 and a “value” thereof.

In step S2, the initialization section 30A makes an entry to the verification-use data management table 34 with a correlation between a “key” being the argument of the initialization function called by the client 60 and a “value” thereof.

In step S3, the initialization section 30A makes an entry of, to the update history management table 36, a “key” being the argument of the initialization function called by the client 60.

With such an initialization process, in response to a call of the initialization function by the client 60, the initialization section 30A initializes all of the tables, i.e., the original data management table 32, the verification-use data management table 34, and the update history management table 36. That is, in response to a call of the initialization function, created is the verification-use data, i.e., the verification-use data management table 34, being a replica of the original data, i.e., the original data management table 32.

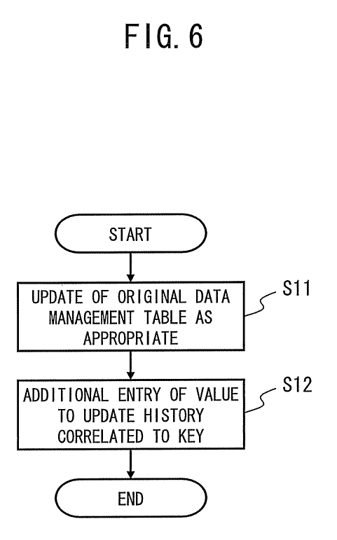

FIG. 6 is a flowchart of an update process to be executed by the update section 30B when an update function (update function) is called by any of the clients 60.

In step S11, the update section 30B updates the original data management table 32. To be specific, the update section 30B refers to the original data management table 32, and updates the value in the original data management table 32 correlated to the “key” being the argument by the update function to which the “value” being the argument is applied. Note here that the value in the original data management table 32 may not be updated depending on the definition of the update function.

In step S12, the update section 30B refers to the update history management table 36, and additionally makes an entry of the “value” being the argument to the update history correlated to the “key” being the argument.

With such an update process, in response to a call of the update function by the client 60, the update section 30B updates the original data management table 32 as appropriate. Moreover, without updating the verification-use data management table 34, the update section 30B additionally makes an entry of a “value” to the update history recorded in the update history management section 36 with a correlation to the “key” being the argument.

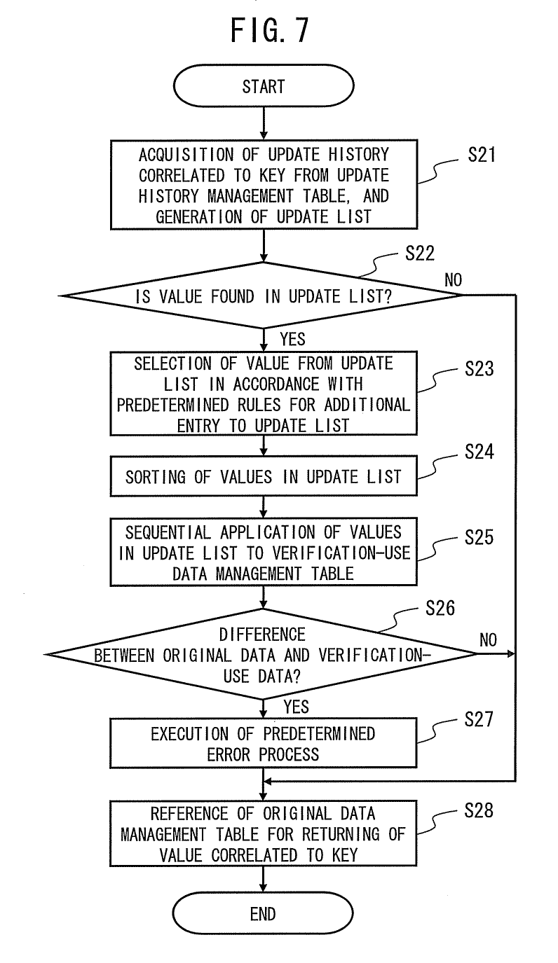

FIG. 7 shows a reference process to be executed by the reference section 30C when a reference function (get function) is called by any of the clients 60.

In step S21, from the update history management table 36, the reference section 30C acquires the update history correlated to the “key” being the argument of the reference function, and generates an update list by providing the acquired update history in the form of a list.

In step S22, the reference section 30C determines whether the update list includes any value or not. When the reference section 30C determines that the update list includes some values, the procedure goes to step S23 (Yes). On the other hand, when the reference section 30C determines that the update list includes no such value, the procedure goes to step S28 (No).

In step S23, the reference section 30C selects at least one value from those found in the update list in accordance with any predetermined rules, and additionally stores the selected value to the update list. Herein, the predetermined rules include a random selection method based on a probability designated by a user for every value, for example.

In step S24, the reference section 30C sorts the values found in the update list. Such sorting of values found in the update list may be performed at random.

In step S25, the reference section 30C stores, in the verification-use data management table 34, the values registered in the update list while applying those values one by one to the update function.

In step S26, the reference section 30C makes a comparison between the original data management table 32 and the verification-use data management table 34, and determines whether any value correlated to a specific key in the original data management table 32 is the same as a value correlated to the same key in the verification-use data management table 34 or not. When the reference section 30C determines that such two values are not the same, the procedure goes to step S27 (Yes), and any predetermined error process is then executed. Herein, with the predetermined error process, an error message may be displayed, or a user-defined error process may be executed, for example. On the other hand, when the reference section 30C determines that such two values are the same, the procedure goes to step S28 (No). Herein, the result of such a comparison between the original data management table 32 and the verification-use data management table 34 may be displayed.

In step S28, the reference section 30C refers to the original data management table 32, and returns the value correlated to the “key” being the argument of the reference function back to the client 60.

With such a reference process, in response to a call of the reference function by the client 60, the reference section 30C acquires the update history correlated to the “key” being the argument from the update history management table 36, thereby generating an update list. The reference section 30C then selects at least one value from those values found in the update list in accordance with any predetermined rules, and additionally stores thus selected value to the update list. Thereafter, the reference section 30C sorts the values found in the update list, and applies the values through with sorting as such to the verification-use data management table 34 one by one. After the completion of the application of the values in the update list, the reference section 30C makes a comparison between the original data management table 32 and the verification-use data management table 34. When any value correlated to a specific key in the original data management table 32 is different from a value correlated to the same key in the verification-use data management table 34, the reference section 30C determines that the user-defined update function is not satisfying both the commutativity and idempotency, and thus executes a predetermined error process.

Accordingly, with such an information processing device, an update task is performed with varying update orders and frequencies, and the results of such an update task are reflected in the verification-use data. This thus enables, with no difficulty, a user to verify whether a user-defined update function is satisfying both the commutativity and idempotency or not. By using the update function proved as is satisfying both the commutativity and idempotency as such, even if each replica is updated in a different update order, or even if any replica is updated similarly for a plurality of times, such results of update can show the same value with a fixed probability. This thus eliminates the need for an overhead for managing the update order and frequency, thereby being able to increase the throughput of update. Moreover, because the information processing device is incorporated in the distributed-data sharing device 10, the verification task can be performed in the state of actual operation. Moreover, the original data management table 32 and the verification-use data management table 34 are each created only for values to be updated by a user-defined update function, thereby being able to prevent any possible increase of load that is generally caused due to the task of verifying the update function.

For easier understanding, a specific example is now described. Exemplified here is a case of storing the maximum values of three variables (x, y, z). In this case, as a definition, an update function f( ) makes a comparison between a current value (current_value) and an update value (update_value), and the larger value of the two is to be returned. The update function f( ) is as below if it is implemented using an open-source programming language, i.e., python, for example.

def f(current_value, update_value):

if (current_value < update_value):

return update_value

else:

return current_value

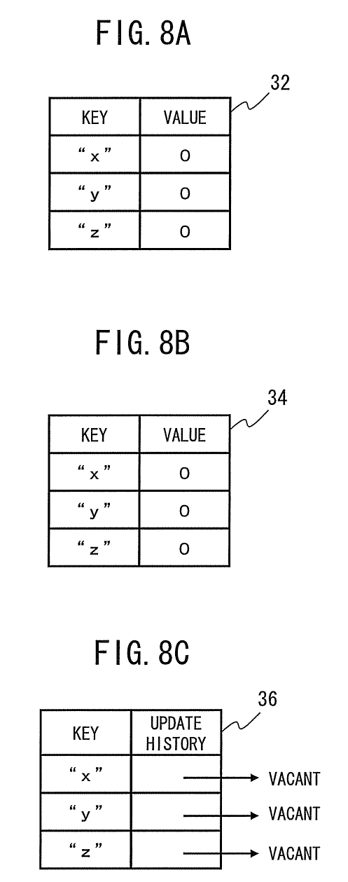

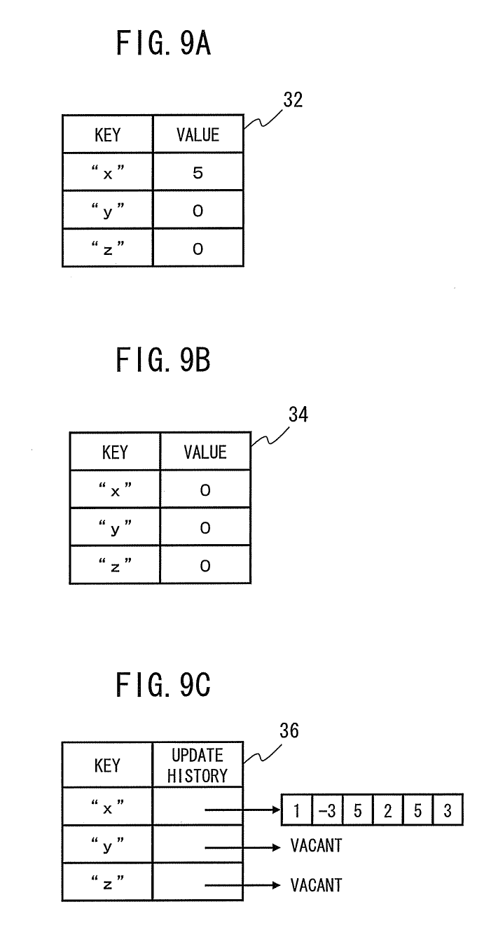

Moreover, the initial values of the variables (x, y, z) are assumed as all being 0. When the initialization function is called by any of the clients 60 with respect to the corresponding server 30, the initialization section 30A initializes the tables, i.e., the original data management table 32, the verification-use data management table 34, and the update history management table 36, to be in the states of FIGS. 8A to 8C, respectively. Thereafter, when the update function of updating the variable x in order of 1, −3, 5, 2, 5, and 3 is sequentially called by the client 60, the update section 30B uses the update function f( ) to update the original data management table 32 to be in the state of FIG. 9A. That is, the update section 30B correlates the maximum value “5” of the variable x to a key “x” for storage into the original data management table 32. On the other hand, in response to a call of the update function, without updating the verification-use data management table 34, the update section 30B keeps the verification-use data management table 34 to be in the initial state as shown in FIG. 9B. The update section 30B also makes entries of values of 1, −3, 5, 2, 5, and 3 to the update history management table 36 as shown in FIG. 9C as the update history correlated to the key “x”.

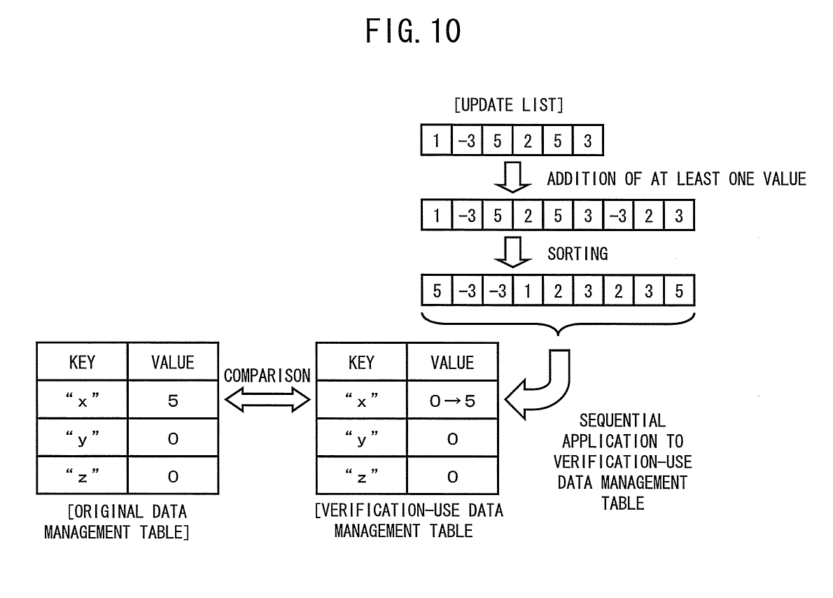

In the states of FIGS. 9A to 9C, when the reference function of the variable x is called from the client 60 to the server 30, as shown in FIG. 10, the reference section 30C acquires the update history (1, −3, 5, 2, 5, 3) correlated to the key “x” from the update history management table 36, thereby generating an update list. The reference section 30C then additionally makes entries of values selected from the resulting update list in accordance with any predetermined rules, i.e., the values of −3, 2, and 3, to the bottom of the update list. The reference section 30C then sorts the values in the update list, and the values through with sorting as such are applied to the update function one by one. The result is stored in the verification-use data management table 34. Thereafter, the reference section 30C refers to the original data management table 32 and the verification-use data management table 34, and determines whether or not any value correlated to the key “x” in the original data management table 32 is different from a value correlated to the same key “x” in the verification-use data management table 34 or not. In an example of FIG. 10, such a value in the original data management table 32 is “5”, and such a value in the verification-use data management table 34 is “5”. Because the two values are the same as such, the user-defined update function f( ) is determined as satisfying both the commutativity and idempotency. On the other hand, if such a value in the original data management table 32 is not the same as such a value in the verification-use data management table 34, the user-defined update function f( ) is determined as not satisfying both the commutativity and idempotency.

In this example, for verification of the update function, used are the original data management table 32, and the verification-use data management table 34. Alternatively, possible options for use include the original data to be updated as appropriate in accordance with the update function, and the verification-use data being a replica of the original data. However, when the original data management table 32 and the verification-use data management table 34 are used, the amount of data to be accessed for verification of the update function will be reduced so that any possible reduction of response can be suppressed in the distributed-data sharing device 10.

The original data being a target for verification may be designated by a user in any arbitrary manner. For designating the original data, for example, a user may designate which server and original data to use when the distributed-data sharing device 10 is activated, or a user may designate the probability of selecting at random which server and original data to use. If this is the case, the original data being a target for verification can be narrowed down, thereby favorably reducing the load needed for verification of the update function, and suppressing any possible reduction of response in the distributed-data sharing device 10.

According to the technology described above, an update task is performed with varying update orders and frequencies, and the results of such an update task are reflected in the verification-use data. This thus enables a user to verify whether a user-defined update function is satisfying both the commutativity and idempotency or not. Moreover, because an information processing device is incorporated in a server, the verification task can be performed in the state of actual operation.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer-readable recording medium encoded with an update function verification program containing instructions executable on a server computer, the server computer managing a plurality of storages by a distributed-data sharing device, the program causing the server computer to execute:
an initialization procedure of creating, when an initialization function is called, verification-use data being a replica of original data;
an update procedure of updating, when an update function is called, the original data using the update function and sequentially storing an argument of the update function to an update history;
a reference procedure of, when a reference function is called, additionally storing at least one of the arguments in the update history to the update history in accordance with predetermined rules and storing the arguments in the update history to the verification-use data while applying the arguments to the update function one by one; and
an error procedure of making a comparison between the original data and the verification-use data including the arguments and, when there is a difference therebetween, executing a predetermined error process.

2. The computer-readable recording medium according to claim 1, wherein the reference procedure additionally stores, to the update history, at least one of the arguments in the update history in accordance with the predetermined rules, sorts the arguments in the update history, and stores the sorted arguments to the verification-use data while applying the arguments to the update function one by one.

3. A computer-readable recording medium encoded with an update function verification program containing instructions executable on a server computer, the server computer managing a plurality of storages by a distributed-data sharing device, the program causing the server computer to execute:
an initialization procedure of, when an initialization function is called, creating verification-use data being a replica of original data;
an update procedure of updating, when an update function is called, the original data using the update function and sequentially storing an argument of the update function to an update history;
a reference procedure of, when a reference function is called, sorting the arguments stored in the update history and storing the arguments in the update history to the verification-use data while applying the arguments to the update function one by one; and
an error procedure of making a comparison between the original data and the verification-use data including the arguments and, when there is a difference therebetween, executing a predetermined error process.

4. An update function verification method to be executed by a server in charge of managing a plurality of storages in a distributed-data sharing device, the method comprising:
creating, when an initialization function is called, verification-use data being a replica of original data;
updating, when an update function is called, the original data using the update function and sequentially storing an argument of the update function to an update history;
additionally storing, to the update history, when a reference function is called, at least one of the arguments in the update history in accordance with predetermined rules and storing the arguments in the update history to the verification-use data while applying the arguments to the update function one by one; and
making a comparison between the original data and the verification-use data including the arguments and, when there is a difference therebetween, executing a predetermined error process.

5. The method according to claim 4, wherein the reference procedure additionally stores, to the update history, at least one of the arguments in the update history in accordance with the predetermined rules, sorts the arguments in the update history, and stores the sorted arguments to the verification-use data while the arguments are being applied to the update function one by one.

6. An information processing device that verifies an update function, the information processing device comprising:
an initialization section creating, when an initialization function is called, verification-use data being a replica of original data;
an update section updating, when an update function is called, the original data using the update function and sequentially storing an argument of the update function to an update history;
a reference section additionally storing, to the update history, when a reference function is called, at least one of the arguments in the update history in accordance with predetermined rules and storing the arguments in the update history in the verification-use data while sequentially applying the arguments to the update function; and
an error section making a comparison between the original data and the verification-use data including the arguments and, when there is a difference therebetween, executing a predetermined error process.

7. The information processing device according to claim 6, wherein the reference section additionally stores, to the update history, at least one of the arguments in the update history in accordance with the predetermined rules, sorts the arguments in the update history, and stores the sorted arguments to the verification-use data while the arguments are being applied to the update function one by one.
